(19) United States
(12) Patent Application Publication
(10) Pub. No.: US 2019/0271761 A1
(43) Pub. Date: Sep. 5, 2019

(54) POSITIONING SYSTEM AND POSITIONING METHOD

(71) Applicants: Inventec Appliances (Pudong) Corporation, Shanghai (CN); Inventec Appliances Corp., New Taipei City (TW); Inventec Appliances (Shanghai) Co., Ltd., Shanghai (CN)

(72) Inventors: Jing-Song CHANG, New Taipei City (TW); Shyh-Shian LIAO, New Taipei City (TW); Yu-Chiang TSAO, New Taipei City (TW)

(21) Appl. No.: 16/178,575

(22) Filed: Nov. 1, 2018

(30) Foreign Application Priority Data
Mar. 1, 2018 (CN) 201810171162.X

(51) Int. Cl. G01S 5/30; G01S 5/22; H04W 4/80; H04W 4/029

(52) U.S. Cl. CPC G01S 5/30; H04W 4/029; H04W 4/80; G01S 5/22

(57) ABSTRACT

A positioning system includes a radio frequency (RF) device, a microphone array, and a calculation device. The RF device is configured to transmit an RF signal to an external device for pairing with the external device. The microphone array is configured to receive an audio signal transmitted from the external device after the positioning system is paired with the external device. The calculation device is configured to calculate a direction from the positioning device to the external device based on a time interval of the audio signal received by the microphone array, and configured to calculate a distance between the positioning system and the external device based on the audio signal transmitted by the external device after pairing. The calculation device is configured to position a location of the external device according to the direction and the distance.

### RELATED APPLICATIONS

This application claims priority to Chinese Application Serial Number 201810171162.X, filed Mar. 1, 2018, which is herein incorporated by reference.

### BACKGROUND

### Field of Invention

The present disclosure relates to a positioning system and a positioning method. More particularly, the present disclosure relates to a positioning system and a positioning method using a microphone array.

### Description of Related Art

People are inevitable to lose items in their daily life. In order to find the lost items, lots of time and effort are usually spent. However, even though the time and effort are spent, it is not always possible to find lost items.

In response to the above situation, there are many anti-lost or lost-and-found products on the market. However, the anti-lost or lost-and-found products currently available on the market have a considerable error in locating items to be found. As a result, not only do users of the anti-lost or lost-and-found products spend money on those products, but the lost items also can not be quickly and efficiently found.

For the foregoing reasons, there is a need to solve the above-mentioned problems by providing a positioning system and a positioning method, which the industry is eager to achieve.

### SUMMARY

The summary aims to provide a brief description of the disclosure so as to provide a basic understanding to the reader. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

A positioning system is provided. The positioning system comprises a radio frequency device, a microphone array, and a calculation device. The radio frequency device is configured to transmit a radio frequency signal to an external device for pairing with the external device. The microphone array is configured to receive an audio signal transmitted from the external device after the positioning system is paired with the external device. The calculation device is configured to calculate a direction from the positioning system to the external device based on a time interval of the audio signal received by the microphone array, and configured to calculate a distance between the positioning system and the external device based on the audio signal transmitted by the external device after pairing. The calculation device positions a location of the external device according to the direction and the distance.

The present disclosure provides a positioning system. The positioning system comprises a radio frequency device, a first microphone array, a second microphone array, and a calculation device. The radio frequency device is configured to transmit a radio frequency signal to an external device. The first microphone array is disposed on one side of the positioning system and configured to receive an audio signal transmitted from the external device after the radio frequency signal is transmitted. The second microphone array is disposed on another side of the positioning system and configured to receive the audio signal transmitted from the external device after the radio frequency signal is transmitted. The calculation device is configured to calculate first orientation information from the positioning system to the external device based on a first time interval of the audio signal received by the first microphone array, and configured to calculate second orientation information from the positioning system to the external device based on a second time interval of the audio signal received by the second microphone array. The calculation device positions a location of the external device based on the first orientation information and the second orientation information.

The present disclosure further provides a positioning method. The positioning method comprises the following steps: transmitting a radio frequency signal to an external device by a radio frequency device of a positioning system for pairing with the external device; receiving an audio signal transmitted from the external device by a microphone array of the positioning system after the positioning system is paired with the external device; calculating a direction from the positioning system to the external device based on a time interval of the audio signal received by the microphone array; calculating a distance between the positioning system and the external device based on the audio signal transmitted by the external device after pairing; and positioning a location of the external device according to the direction and the distance.

Therefore, the embodiments of the present disclosure provide a positioning system and a positioning method that is able to quickly, conveniently, and accurately locate the items to be found based on technical content of the present disclosure.

Many of the attendant features will be more readily appreciated as the same becomes better understood by reference to the following detailed description considered in connection with the accompanying drawings.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 depicts a schematic diagram of a positioning system and an external device according to one embodiment of the present disclosure;

FIG. 2 depicts a schematic diagram of a microphone array of the positioning system in FIG. 1 according to one embodiment of the present disclosure;

FIG. 3A depicts a schematic diagram of a microphone array of the positioning system in FIG. 1 according to another embodiment of the present disclosure;

FIG. 3B depicts a schematic diagram of a microphone array of the positioning system in FIG. 1 according to still another embodiment of the present disclosure.

FIG. 4 depicts a schematic diagram of relative relationships between a microphone array and an external device according to one embodiment of the present disclosure;

FIG. 5 depicts a schematic diagram of relative relationships between a microphone array and an external device according to another embodiment of the present disclosure;

FIG. 6 depicts a schematic diagram of relative relationships between a microphone array and an external device according to still another embodiment of the present disclosure;

FIG. 7 depicts a schematic diagram of relative relationships between a microphone array and an external device according to yet another embodiment of the present disclosure;

FIG. 8 depicts a schematic diagram of relative relationships between a microphone array and an external device according to another embodiment of the present disclosure;

FIG. 9 depicts a schematic diagram of a configuration of a microphone array according to one embodiment of the present disclosure; and

FIG. 10 depicts a flowchart of a positioning method according to one embodiment of the present disclosure.

According to the usual mode of operation, various features and elements in the figures have not been drawn to scale, which are drawn to the best way to present specific features and elements related to the present disclosure. In addition, among the different figures, the same or similar element symbols refer to similar elements/components.

### DESCRIPTION OF THE EMBODIMENTS

To make the contents of the present disclosure more thorough and complete, the following illustrative description is given with regard to the implementation aspects and embodiments of the present disclosure, which is not intended to limit the scope of the present disclosure. The features of the embodiments and the steps of the method and their sequences that constitute and implement the embodiments are described. However, other embodiments may be used to achieve the same or equivalent functions and step sequences.

Unless otherwise defined herein, scientific and technical terminologies employed in the present disclosure shall have the meanings that are commonly understood and used by one of ordinary skill in the art. Unless otherwise required by context, it will be understood that singular terms shall include plural forms of the same and plural terms shall include the singular. Specifically, as used herein and in the claims, the singular forms “a” and “an” include the plural reference unless the context clearly indicates otherwise.

As used herein, “couple” refers to direct physical contact or electrical contact or indirect physical contact or electrical contact between two or more elements. Or it can also refer to reciprocal operations or actions between two or more elements.

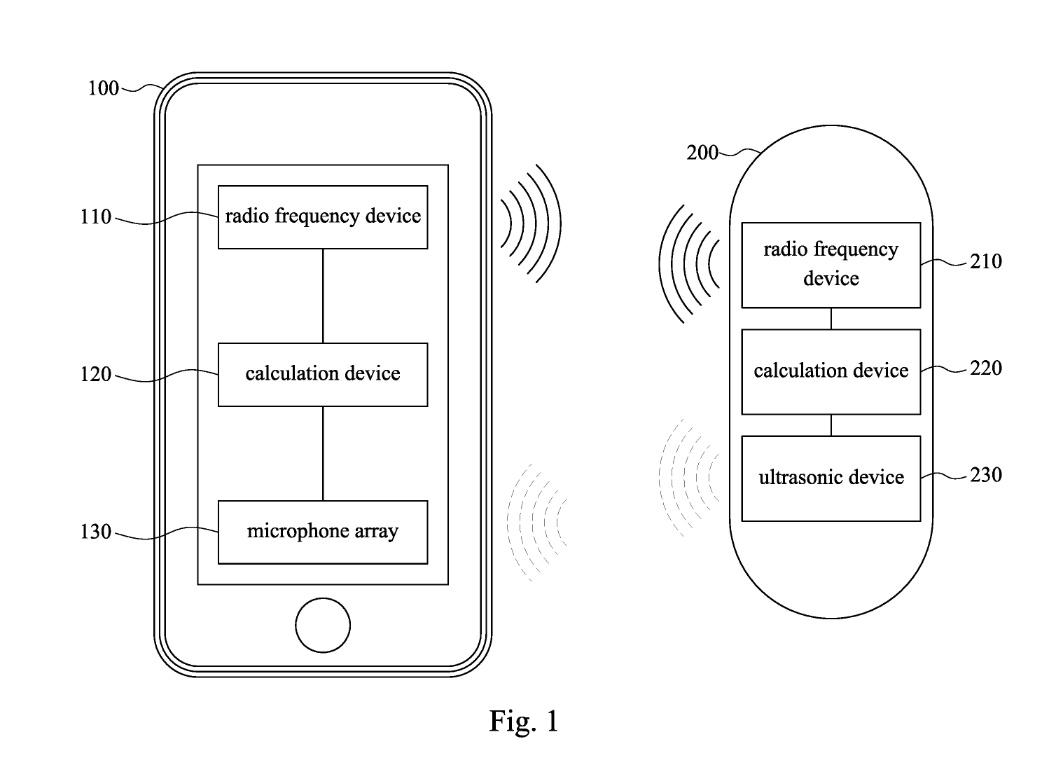

FIG. 1 depicts a schematic diagram of a positioning system and an external device according to one embodiment of the present disclosure. As shown in the figure, the positioning system 100 comprises a radio frequency device 110, a calculation device 120, and a microphone array 130. As for the structure, the calculation device 120 of the positioning system 100 is connected to the radio frequency device 110 and the microphone array 130. In addition, a calculation device 220 of an external device 200 is connected to a radio frequency device 210 and an ultrasonic device 230. It is noted that the present disclosure is not limited to the structure and related configurations shown in FIG. 1, which is only used to illustrate an example of one of the implementation methods of the present disclosure. Any modifications, variations, and alternations, etc., made to the structure of the present disclosure without departing from the scope or spirit of the present disclosure are within the scope of the present disclosure.

As for operation, the radio frequency device 110 is configured to transmit a radio frequency signal to the external device 200 for pairing with the external device 200. For example, the radio frequency device 110 in the positioning system 100 is able to communicate and pair with the radio frequency device 210 in the external device 200 bidirectionally to facilitate the external device 200 to accurately respond in a real-time manner when the positioning system 100 transmits a positioning/distance measuring request subsequently. A description of detailed operations is provided as follows.

In addition, the microphone array 130 is configured to receive an audio signal transmitted from the external device 200 after the positioning system 100 is paired with the external device 200. For example, after the microphone array 130 is paired with the external device 200, the positioning system 100 may transmit the distance measuring signal to the external device 200 according to user requirements (such as a lost-and-found requirement). The external device 200 will return the audio signal to the positioning system 100 once receiving the distance measuring signal. Then, the calculation device 120 of the positioning system 100 calculates a distance based on the audio signal. In some embodiments, the external device 200 returns the audio signal to the positioning system 100 at a first distance measuring time after receiving the distance measuring signal. After that, the positioning system 100 receives the audio signal at a second distance measuring time. In this manner, the distance can be accurately calculated by the calculation device 120 based on a difference between the first distance measuring time and the second distance measuring time. In other words, after the calculation device 120 obtains a time point at which the external device 200 returns the audio signal and recognizes a time point at which the positioning system 100 receives the audio signal, the calculation device 120 can calculate a distance between the positioning system and the external device based on a time interval between the above two time points.

Additionally, the calculation device 120 is configured to calculate a direction from the positioning system 100 to the external device 200 based on a time interval of the audio signal received by the microphone array 130. In this manner, the calculation device 120 can position a location of the external device 200 based on the direction from the positioning system 100 to the external device 200 and the distance between the positioning system 100 and the external device 200 after the calculation device 120 calculates the direction and the distance.

In one embodiment, the audio signal transmitted by the external device 200 may be an ultrasonic wave, but the present disclosure is not limited in this regard. Any wave that is able to be transmitted/emitted from the external device 200 and propagated by air or some other medium and received by the positioning system 100 is within the scope of the present disclosure.

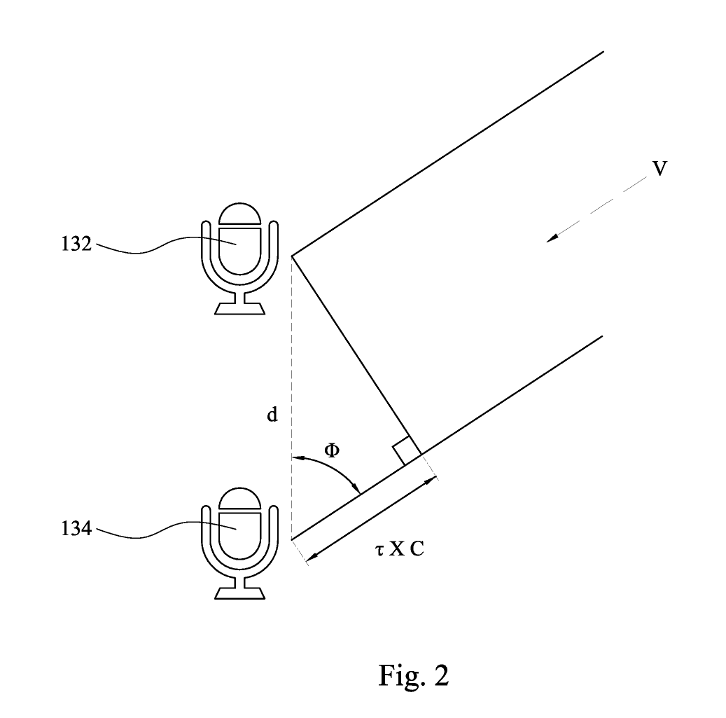

FIG. 2 depicts a schematic diagram of a microphone array of the positioning system in FIG. 1 according to one embodiment of the present disclosure. As shown in the figure, an example of the microphone array 130 of the positioning system 100 in FIG. 1 is depicted to facilitate understanding the positioning principle of the present disclosure. The microphone array 130 comprises microphones 132, 134 according to the present embodiment. To facilitate illustration and understanding, the microphones 132, 134 in the figure are arranged in a vertical line. However, the present disclosure is not limited in this regard. It is assumed that an orientation of an audio signal V transmitted from the external device 200 in FIG. 1 is shown as FIG. 2. Since there is an angle between the audio signal V and the vertical line at which the microphone 132, 134 are located, the time interval exists when the audio signal transmitted from the external device 200 reaches the microphones 132, 134. The angle between the external device 200 and the microphones 132, 134 can be derived based on the time interval. A detailed calculation method is described as follows.

A description is provided with reference to FIG. 1 and FIG. 2. It is assumed that there is a distance d between the microphones 132, 134. In addition, the time interval of the audio signal V transmitted from the external device 200 is τ when reaching the microphones 132, 134. The acoustic wave velocity is c. Therefore, a distance can be calculated as τ×c, and the following equation is derived:

$$Cos φ = \frac{τ \times c}{d} \qquad eq 1$$

If equation 1 is further rearranged, an angle ϕ between the external device 200 and the microphone is obtained. See the following equation:

$$φ = {Cos}^{- 1} \frac{τ \times c}{d} \qquad eq 2$$

As shown in equation 2, in some embodiments, angles between the external device 200 and various microphones (acoustic incident angles) can be respectively calculated by using the various microphones. Then, an incident direction of the audio signal V (such as an ultrasonic wave) transmitted from the external device 200 can be calculated through the plurality of angles. In addition, through the above distance measuring method, the positioning system 100 calculates the distance between the positioning system 100 and the external device 200. As a result, the location of the external device 200 can be accurately obtained with the direction and distance.

For example, the positioning system 100 may be used for anti-lost/lost-and-found applications. A user can place the external device 200 within an easily lost item, for example, the external device 200 may be placed inside a bag. Once the bag is lost/undetectable by the naked eye, pairing/bidirectional communication with the external device 200 can be performed through the positioning system 100. The external device 200 thus returns the ultrasonic wave, and the positioning system 100 then calculates the orientation and distance based on the ultrasonic wave to position an accurate location of the bag. In this manner, the bag can be quickly, conveniently, and accurately located. However, the present disclosure is not limited to the above embodiment. The external device 200 according to the present disclosure may be placed or embedded in various items, and the positioning system 100 may be embedded in various devices. For example, the positioning system 100 may be embedded in a mobile phone, and an application (APP) of the mobile phone cooperates with the positioning system 100 to search for items and displays the search results on a screen of the mobile phone, so that the user can quickly, conveniently, and accurately locate the items to be searched for. Or, the positioning system 100 and the external device 200 may be respectively embedded in different mobile phones to facilitate the use of one mobile phone to find another mobile phone. Or, the positioning system 100 and the external device 200 may be respectively embedded in a computer and a mobile phone to facilitate the use of the computer to find the mobile phone. Or, other similar configuration methods are within the scope of the present disclosure.

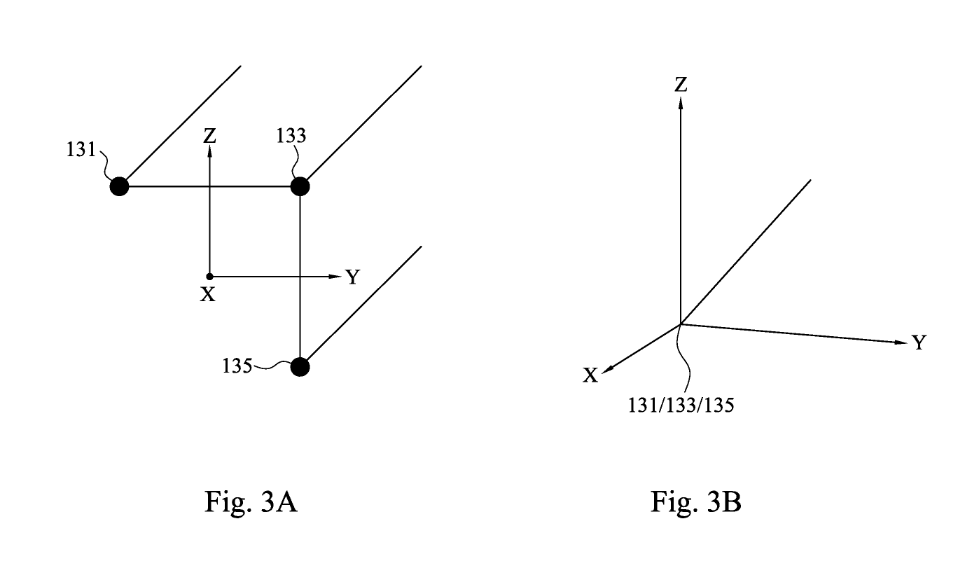

FIG. 3A depicts a schematic diagram of a microphone array of the positioning system in FIG. 1 according to another embodiment of the present disclosure. FIG. 3B depicts a schematic diagram of a microphone array of the positioning system in FIG. 1 according to still another embodiment of the present disclosure. As shown in FIG. 3A, the microphone array 130 comprises microphones 131, 133, 135, and the three may be arranged in a triangle. The triangle may be but not limited to a right triangle. A description is provided with reference to FIG. 1 and FIG. 3A. As for operation, it is assumed that distances between the external device 200 and the microphones 131, 133, 135 are all different. The microphone 131 will receive the audio signal at a first time. The microphone 133 will receive the audio signal at a second time. The microphone 135 will receive the audio signal at a third time. A first time interval exists between the first time and the second time. A second time interval exists between the second time and the third time. Then, the calculation device 120 can calculate the direction based on the first time interval and the second time interval. In short, the calculation device 120 can calculate the direction based on the time interval of the audio signal returned from the external device 200 and receive by each two of the microphones 131, 133, 135.

A description is provided with reference to FIG. 3B. If viewed from a distance, the triangle in which the microphones 131, 133, 135 of FIG. 3A are arranged can be regarded as one point (origin), and there are two axes (Y axis, Z axis) on the YZ plane that are different by 90 degrees and pass through the origin. However, the present disclosure is not limited to the structures and related configurations shown in FIG. 3A and FIG. 3B, which is only used to depict an example of one of the implementation methods of the present disclosure. Any means, such as modifications, variations, alternations, etc., made to the structures and related configurations of the present disclosure without departing from the scope or spirit of the present disclosure are within the scope of the present disclosure.

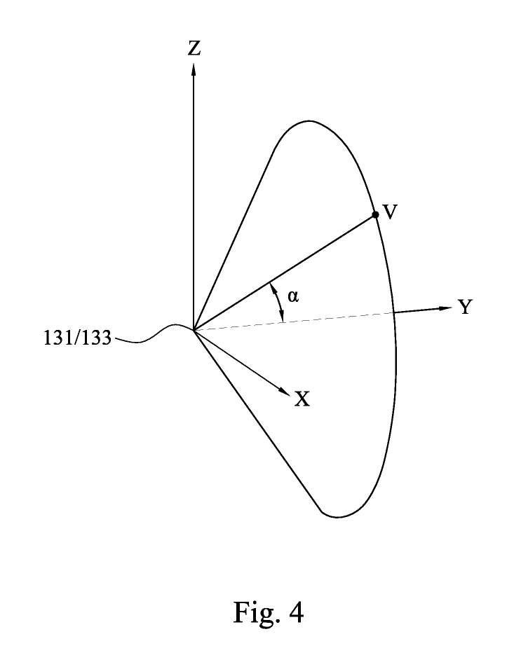

Under the preset condition of FIG. 3B, a description is provided with reference to an embodiment of FIG. 4. FIG. 4 depicts a schematic diagram of relative relationships between a microphone array and an external device according to one embodiment of the present disclosure. A description is provided with reference to FIG. 1 and FIG. 4. If the microphones 131, 133 are both located at the original and there is a time interval between the audio signal V transmitted from the external device 200 to the microphones 131, 133, an incident angle a can be calculated by the calculation device 120. Since at this time only the incident angle a from the external device 200 to the microphones 131, 133 is obtained and the accurate location of the external device 200 is not known yet, each point on the bottom circle of a cone drawn with the Y-axis as the central axis and the included angle with the Y-axis being a is the possible location of the external device 200. A description is provided as follows as to how to calculate the accurate location of the external device 200 in detail.

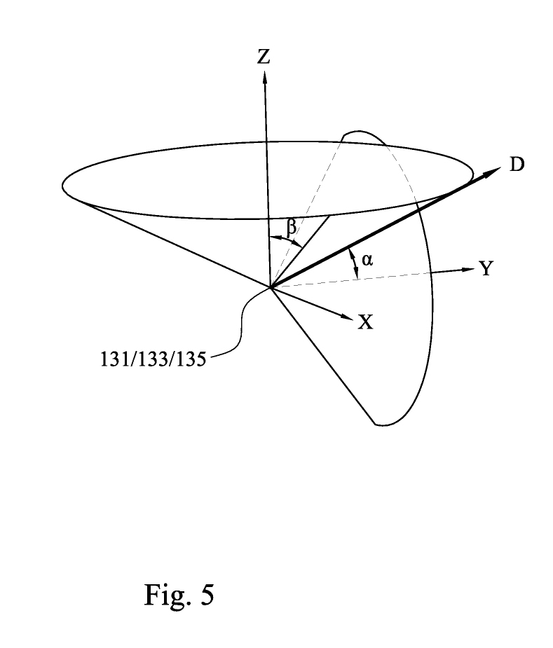

FIG. 5 depicts a schematic diagram of relative relationships between a microphone array and an external device according to another embodiment of the present disclosure. As compared with FIG. 4, a microphone 135 is added in FIG. 5. Therefore, another incident angle β can be calculated by the calculation device 120 of FIG. 1, and another cone is obtained. As shown in the figure, the two cones intersect along a straight line (such as a straight line in a direction D). The calculation device 120 in FIG. 1 positions the external device 200 on the straight line, and the external device 200 is positioned at a location that has the above calculated distance from the microphones 131, 133, 135 of the positioning system 100. For example, if the measured distance is 2 meters and the external device 200 is known to be located on the straight line in the direction D, the external device 200 can be positioned on the straight line in the direction D and is 2 meters from the origin. The above straight line can be calculated by the following equations:

X²+Z²=tan(α)²Y² eq(3)

X²+Y²=tan (β)²Z² eq(4)

Subtract equation 3 from equation 4 to obtain the following equation:

Y²−Z²=tan(β)²Z²−tan(α)²Y² eq(5)

Rearrange equation 5 to obtain the following equation:

(1+tan(α)²)Y²=(1+tan(β)²)Z² eq(6)

The equations of straight line can be derived from the above equation 6:

$$\begin{matrix}Z = \sqrt{\frac{1 + {tan ( α )}^{2}}{1 + {tan ( β )}^{2}}} Y & eq ( 7 ) \\ X = \sqrt{\frac{{tan ( α )}^{2} {tan ( β )}^{2} - 1}{1 + {tan ( β )}^{2}}} Y & eq ( 8 )\end{matrix}$$

Additionally, in other embodiments, a polar coordinate solution can be adopted. The equation is as follows:

$$γ = \sqrt{{Y}^{2} + {X}^{2} + {Z}^{2}} = \sqrt{{Y}^{2} + \frac{{tan ( α )}^{2} {tan ( β )}^{2} - 1}{1 + {tan ( β )}^{2}} {Y}^{2} + \frac{1 + {tan ( α )}^{2}}{1 + {tan ( β )}^{2}} {Y}^{2}} \qquad eq ( 9 )$$

Rearrange equation 9 to obtain the following equation:

γ=(\sqrt{1+tan(α)²})Y eq(10)

Continue using the polar coordinate solution, the equation is as follows:

$$θ = {tan}^{- 1} ( \sqrt{\frac{{Y}^{2} + {X}^{2}}{{Z}^{2}}} ) = {tan}^{- 1} ( \sqrt{\frac{{Y}^{2} + \frac{{tan ( α )}^{2} {tan ( β )}^{2} - 1}{1 + {tan ( β )}^{2}} {Y}^{2}}{\frac{1 + {tan ( α )}^{2}}{1 + {tan ( β )}^{2}} {Y}^{2}}} ) = β \qquad eq 11$$

The equation for another polar coordinate solution is as follows:

$$φ = {tan}^{- 1} ( \frac{Y}{X} ) = {tan}^{- 1} ( \sqrt{\frac{1 + {tan ( β )}^{2}}{{tan ( α )}^{2} {tan ( β )}^{2} - 1}} ) \qquad eq 12$$

However, the present disclosure is not limited to the above embodiment, which is only used to illustrate an example of one of the implementation methods of the present disclosure. Any variations of the above parameters, such as angle, cone, direction, etc., without departing from the scope or spirit of the present disclosure are within the scope of the present disclosure.

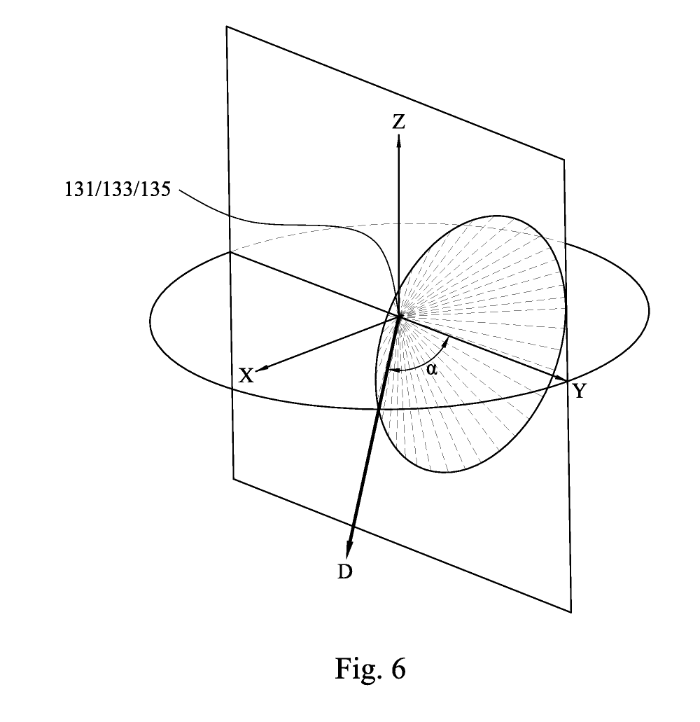

FIG. 6 depicts a schematic diagram of relative relationships between a microphone array and an external device according to still another embodiment of the present disclosure. As compared with FIG. 5, in FIG. 6 the another incident angle is 90 degrees. Hence, a cone formed with the angle β in FIG. 5 is distributed on the XY plane. A cone formed with the incident angle a and the XY plane intersects along a straight line (such as a straight line in the direction D). The external device 200 is located on the straight line in the direction D. If the measured distance is 2 meters, the external device 200 can be positioned on the straight line in the direction D and is 2 meters from the origin. The above straight line can be calculated by the following equations:

Z=0 eq (13)

X²+Z²=tan(α)²Y² eq(14)

Substitute equation 13 into equation 14 to obtain the following equation:

X²=tan(α)²Y² eq(15)

Rearrange equation 15 to obtain the equation of straight line:

X=tan(α)Y eq(16)

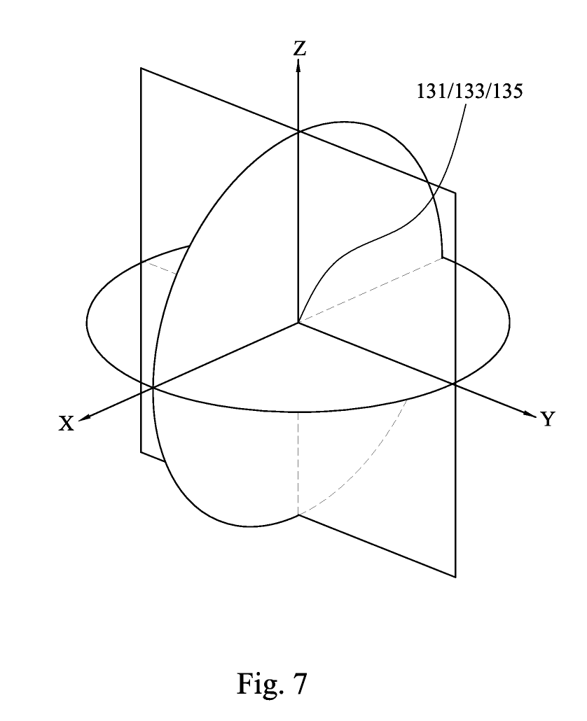

FIG. 7 depicts a schematic diagram of relative relationships between a microphone array and an external device according to yet another embodiment of the present disclosure. As compared with FIG. 6, in FIG. 7 the incident angles angels α, β are both 90 degrees. Hence, not only is the cone formed with the angle β distributed on the XY plane, but the cone formed with the angle α is also distributed on another plane, that is, the XZ plane. The two cones intersect along a straight line (such as a straight line in X direction). The external device 200 is located on the straight line in the X direction. If the measured distance is 2 meters, the external device 200 can be positioned on the straight line in the X direction and is 2 meters from the origin. The above straight line can be calculated by the following equations:

Z=0 eq 17

Y=0 eq 18

Under the condition that both equation 17 and equation 18 are satisfied, the external device 200 is located on the X axis.

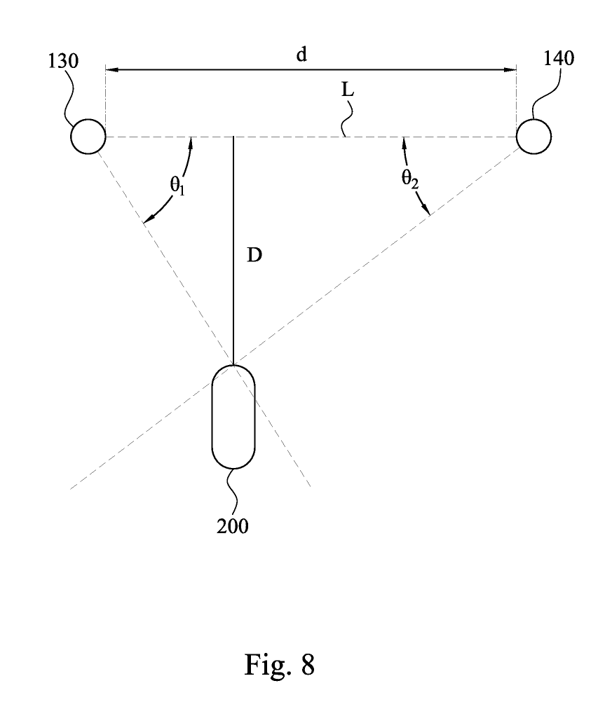

FIG. 8 depicts a schematic diagram of relative relationships between a microphone array and an external device according to another embodiment of the present disclosure. Another microphone array 140 is further added in FIG. 8 based on the positioning system 100 shown in FIG. 1. A description is provided with reference to FIG. 1 and FIG. 8. As for the structure, the microphone arrays 130, 140 are respectively disposed on two sides of the positioning system 100, and a distance between the two is d. However, the present disclosure is not limited to the structure and related configurations shown in FIG. 8, which is only used to depict an example of one of the implementation methods of the present disclosure. Any means, such as modifications, variations, alternations, etc., made to the structure and related configurations of the present disclosure without departing from the scope or spirit of the present disclosure are within the scope of the present disclosure.

As for operation, the microphone arrays 130, 140 are configured to receive the audio signal transmitted from the external device 200. The calculation device 120 calculates first orientation information from the positioning system 100 to the external device 200 based on a first time interval of the audio signal received by the microphone array 130. In addition, the calculation device 120 calculates second orientation information from the positioning system 100 to the external device 200 based on a second time interval of the audio signal received by the microphone array 140. Since the basic calculation method of the orientation information (including angles) has been described in the embodiment shown FIG. 2, a description in this regard is not provided. After that, the calculation device 120 positions the location of the external device 200 based on the first orientation information and the second orientation information.

A description is provided with reference to FIG. 1 and FIG. 8. In some embodiments, each of the microphone arrays 130, 140 comprises a plurality of microphones. The audio signal received by each two of the microphones in the microphone array 130 has the first time interval, and the calculation device 120 calculates the first orientation information from the positioning system 100 to the external device 200 based on at least two of the first time intervals. In addition to that, the audio signal received by each two of the microphones in the microphone array 140 has the second time interval, and the calculation device 120 calculates the second orientation information from the positioning system 100 to the external device 200 based on at least two of the second time intervals. For example, the calculation device 120 calculates a first orientation angle 81 from the positioning system 100 to the external device 200 based on at least two of the first time intervals of the microphone array 130, and calculates a second orientation angle θ2 from the positioning system 100 to the external device 200 based on at least two of the second time intervals of the microphone array 140.

For example, the first orientation information and the second orientation information comprise the first orientation angle 81, the second orientation angle θ2, and the distance d between the microphone array 130 and the microphone array 140. As shown in FIG. 8, a distance D between the external device 200 and a line L connecting the microphone array 130 and the microphone array 140 can be calculated based on the triangle theorem so as to position the location of the external device 200.

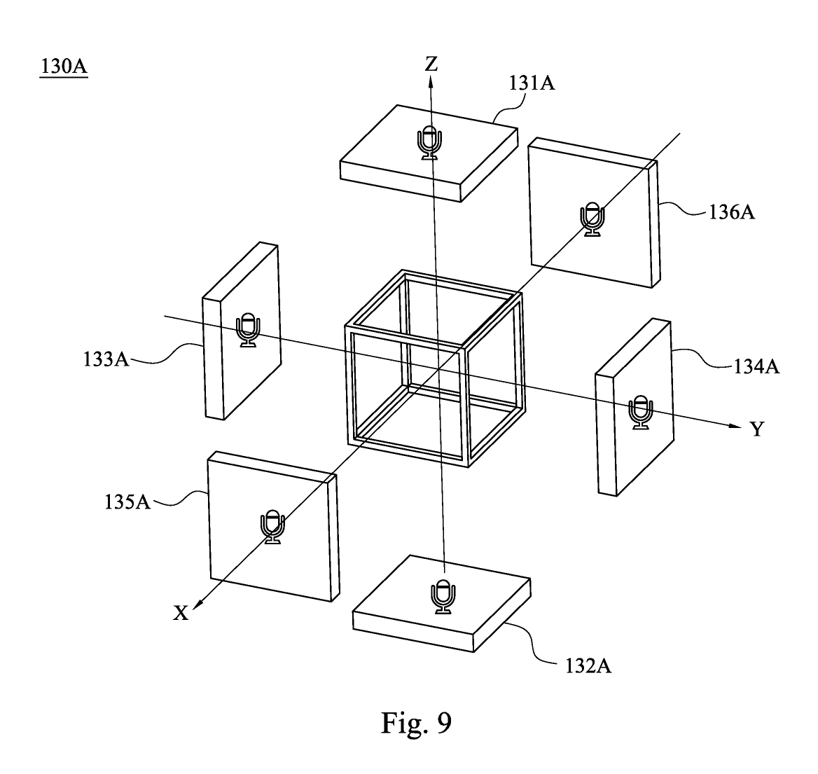

FIG. 9 depicts a schematic diagram of a configuration of a microphone array according to one embodiment of the present disclosure. Each of the microphone array 130 and the microphone array 140 in FIG. 8 may be configured in the manner shown in FIG. 9. For example, a description is provided with reference to FIG. 1, FIG. 8, and FIG. 9. A microphone array 130A comprises a first microphone pair 131A, 132A, a second microphone pair 133A, 134A, and a third microphone pair 135A, 136A. Each of the microphone pairs has a time interval when receiving the audio signal transmitted from the external device 200. Therefore, the calculation device 120 can obtain the time intervals respectively from the first microphone pair 131A, 132A, the second microphone pair 133A, 134A, and the third microphone pair 135A, 136A, and then calculate the first orientation angle θ1 based on the time intervals.

Similarly, the microphone array 140 in FIG. 8 may also comprise three microphone pairs. Each of the microphone pairs similarly has a time interval when receiving the audio signal transmitted from the external device 200. Therefore, the calculation device 120 can obtain the time intervals respectively from the three microphone pairs of the microphone array 140, and then calculate the second orientation angle θ2 based on the time intervals. Additionally, the distance between the microphone array 130 and the microphone array 140 is known to be d. Accordingly, the calculation device 120 can thus position the location of the external device 200 based on the first orientation angle θ1, the second orientation angle θ2, and the distance d.

In some embodiments, as shown in FIG. 9, a line connecting the first microphone pair 131A, 132A, a line connecting the second microphone pair 133A, 134A, and a line connecting the third microphone pair 135A, 136A are perpendicular to one another. Similarly, each two lines of the three microphone pairs of the microphone array 140 are perpendicular to each other. In other words, the line connecting the first microphone pair 131A, 132A is located on the Z axis, the line connecting the second microphone pair 133A, 134A is located on the Y axis, and the line connecting the third microphone pair 135A, 136A is located on the X axis. Therefore, each two lines of the three microphone pairs are perpendicular to each other. However, the present disclosure is not limited to the structure and related configurations shown in FIG. 9, which is only used to depict an example of one of the implementation methods of the present disclosure. Any means, such as modifications, variations, alternations, etc., made to the structure and related configurations of the present disclosure without departing from the scope or spirit of the present disclosure are within the scope of the present disclosure.

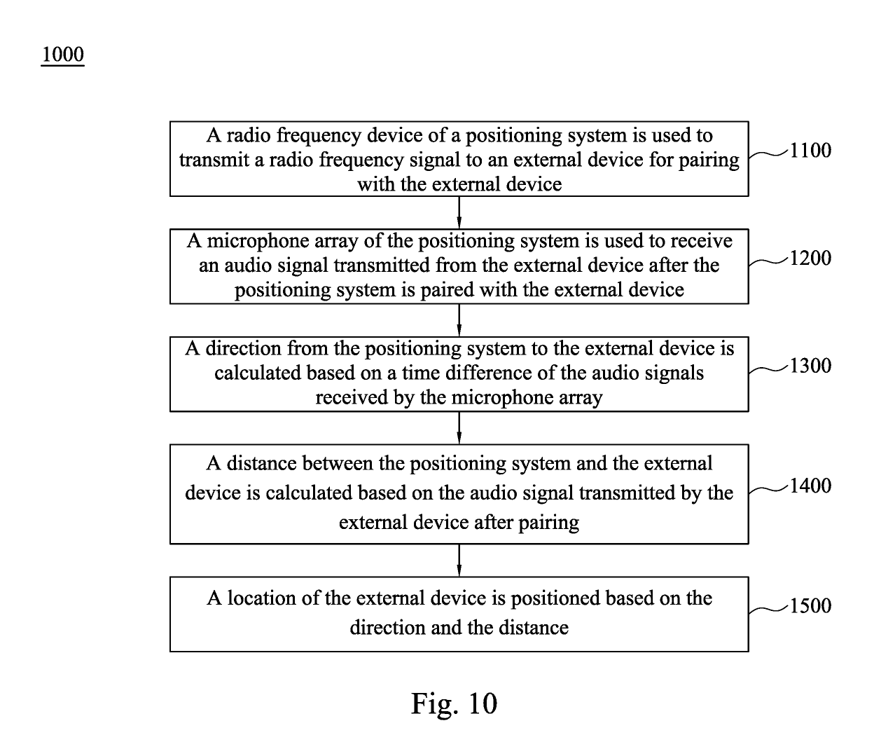

FIG. 10 depicts a flowchart of a positioning method according to one embodiment of the present disclosure. As shown in the figure, the positioning method 1000 comprises the following steps:

Step 1100: A radio frequency device of a positioning system is used to transmit a radio frequency signal to an external device for pairing with the external device;

Step 1200: A microphone array of the positioning system is used to receive an audio signal transmitted from the external device after the positioning system is paired with the external device;

Step 1300: A direction from the positioning system to the external device is calculated based on a time interval of the audio signal received by the microphone array;

Step 1400: A distance between the positioning system and the external device is calculated based on the audio signal transmitted by the external device after pairing; and

Step 1500: A location of the external device is positioned based on the direction and the distance.

In order to facilitate the understanding of the positioning method 1000 according to the embodiment of the present disclosure, a description is provided with reference to FIG. 1 and FIG. 10. In step 1100, the radio frequency device 110 of the positioning system 100 may be used to transmit a radio frequency signal to the external device 200 for pairing with the external device 200. In step 1200, the microphone array 130 of the positioning system 100 may be used to receive an audio signal transmitted from the external device 200 after the positioning system 100 is paired with the external device 200.

In addition, in step 1300, the calculation device 120 may be used to calculate a direction from the positioning system 100 to the external device 200 based on a time interval of the audio signal received by the microphone array 130. In step 1400, the calculation device 120 may be used to calculate a distance between the positioning system 100 and the external device 200 based on the audio signal transmitted by the external device 200 after pairing. In step 1500, the calculation device 120 may be used to position a location of the external device 200 based on the direction and the distance.

In another embodiment, a description is provided with reference to FIG. 1 and FIG. 10. The microphone array 130 comprises a plurality of microphones. The audio signal received by each two of the microphones among these microphones has the time interval. In the above step 1300, the step of calculating the direction from the positioning system to the external device comprises: the calculation device 120 may be used to calculate the direction from the positioning system 100 to the external device 200 based on at least two time intervals of the time interval generated by each two of the microphones.

In still another embodiment, a description is provided with reference to FIG. 1, FIG. 3A, and FIG. 10. The microphone array 130 comprises the microphones 131, 133, 135. It is assumed that distances between the external device 200 and the microphones 131, 133, 135 are all different, then the positioning method 1000 comprises the following steps: The microphone 131 receives the audio signal at a first time. The microphone 133 receives the audio signal at a second time. The microphone 135 receives the audio signal at a third time. The calculation device 120 may be used to calculate a first time interval based on the first time and the second time, and calculate a second time interval based on the second time and the third time. In addition, in the above step 1300, the step of calculating the direction from the positioning system 100 to the external device 200 comprises: the calculation device 1200 may be used to calculate the direction from the positioning system 100 to the external device 200 based on the first time interval and the second time interval.

In yet another embodiment, in the above step 1400, the step of calculating the distance between the positioning system 100 and the external device 200 comprises: The positioning system 100 may be used to transmit a distance measuring signal to the external device 200 after the positioning system 100 is paired with the external device 200, and the external device 200 returns the audio signal to the positioning system 100 at a first distance measuring time after receiving the distance measuring signal. The positioning system 100 may be used to receive the audio signal at a second distance measuring time. The calculation device 120 may be used to calculate the distance between the positioning system 100 and the external device 200 based on the first distance measuring time and the second distance measuring time.

It is understood from the embodiments of the present disclosure that application of the present disclosure has the following advantages. The positioning system and positioning method according to the embodiments of the present disclosure adopt the microphone array to accurately locate the direction of the item to be found. In addition to that, the radio frequency device is used to transmit a radio frequency signal to the external device for pairing with the external device. The distance to the item to be found is thus obtained. As a result, the positioning system and positioning method according to the embodiments of the present disclosure can quickly, conveniently, and accurately locate the external device (may be placed/embedded in the item to be found in advance to facilitate locating the item). In addition to that, the positioning system and positioning method according to the embodiments of the present disclosure further adopt two microphone arrays. By using the originally known distance between the two microphone arrays and the individual orientation information calculated from the two microphone arrays (such as the included angles respectively between the two microphone arrays and the external device), the triangle theorem is employed to quickly, conveniently, and accurately locate the external device (may be placed/embedded in the item to be found in advance).

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A positioning system comprising:
a radio frequency device configured to transmit a radio frequency signal to an external device for pairing with the external device;
a microphone array configured to receive an audio signal transmitted from the external device after the positioning system is paired with the external device; and
a calculation device configured to calculate a direction from the positioning system to the external device based on a time interval of the audio signal received by the microphone array, and configured to calculate a distance between the positioning system and the external device based on the audio signal transmitted by the external device after pairing, wherein the calculation device positions a location of the external device according to the direction and the distance.

2. The positioning system of claim 1, wherein the microphone array comprises:
a plurality of microphones, wherein the audio signal received by each two microphones of the microphones has the time interval, wherein the calculation device calculates the direction based on at least two of the time intervals.

3. The positioning system of claim 1, wherein the microphone array comprises:
a first microphone configured to receive the audio signal at a first time;
a second microphone configured to receive the audio signal at a second time; and
a third microphone configured to receive the audio signal at a third time;
wherein the first time and the second time comprise a first time interval, the second time and the third time comprise a second time interval, wherein the calculation device calculates the direction based on the first time interval and the second time interval.

4. The positioning system of claim 3, wherein the calculation device calculates a first incident angle based on the first time interval and calculates a second incident angle based on the second time interval, wherein the calculation device calculates the direction based on the first incident angle and the second incident angle.

5. The positioning system of claim 4, wherein the calculation device calculates a first cone based on the first incident angle and calculates a second cone based on the second incident angle, the first cone and the second cone intersect along a straight line, wherein the calculation device positions the external device on the straight line, and the external device is positioned at a location that has the distance from the positioning system.

6. The positioning system of claim 3, wherein the first microphone, the second microphone, and the third microphone are arranged in a triangle.

7. The positioning system of claim 5, wherein the positioning system transmits a distance measuring signal to the external device after the positioning system is paired with the external device, the external device returns the audio signal to the positioning system after receiving the distance measuring signal to allow the calculation device to calculate the distance based on the audio signal.

8. The positioning system of claim 7, wherein the external device returns the audio signal to the positioning system at a first distance measuring time after receiving the distance measuring signal, wherein the positioning system receives the audio signal at a second distance measuring time to allow the calculation device to calculate the distance based on the first distance measuring time and the second distance measuring time.

9. A positioning system comprising:
a radio frequency device configured to transmit a radio frequency signal to an external device;
a first microphone array disposed on one side of the positioning system and configured to receive an audio signal transmitted from the external device after the radio frequency signal is transmitted;
a second microphone array disposed on another side of the positioning system and configured to receive the audio signal transmitted from the external device after the radio frequency signal is transmitted; and
a calculation device configured to calculate first orientation information from the positioning system to the external device based on a first time interval of the audio signal received by the first microphone array, and configured to calculate second orientation information from the positioning system to the external device based on a second time interval of the audio signal received by the second microphone array, wherein the calculation device positions a location of the external device based on the first orientation information and the second orientation information.

10. The positioning system of claim 9, wherein the first microphone array comprises:
a plurality of first microphones, wherein the audio signal received by each two first microphones of the first microphones has the first time interval, wherein the calculation device calculates the first orientation information from the positioning system to the external device based on at least two of the first time intervals;
wherein the second microphone array comprises:
a plurality of second microphones, wherein the audio signal received by each two second microphones of the second microphones has the second time interval, wherein the calculation device calculates the second orientation information from the positioning system to the external device based on at least two of the second time intervals.

11. The positioning system of claim 10, wherein the calculation device calculates a first orientation angle based on the at least two of the first time intervals and calculates a second orientation angle based on the at least two of the second time intervals.

12. The positioning system of claim 11, wherein the first orientation information and the second orientation information comprise the first orientation angle, the second orientation angle, and a distance between the first microphone array and the second microphone array, wherein the calculation device positions the location of the external device based on the first orientation angle, the second orientation angle, and the distance.

13. The positioning system of claim 9, wherein the first microphone array comprises a first microphone pair, a second microphone pair, and a third microphone pair, wherein the calculation device obtains time intervals respectively from the first microphone pair, the second microphone pair, and the third pair, and then calculates a first orientation angle based on the time intervals.

14. The positioning system of claim 13, wherein the second microphone array comprises a fourth microphone pair, a fifth microphone pair, and a sixth microphone pair, wherein the calculation device obtains time intervals respectively from the fourth microphone pair, the fifth microphone pair, and the sixth pair, and then calculates a second orientation angle based on the time intervals.

15. The positioning system of claim 14, wherein a line connecting two microphones of the first microphone pair, a line connecting two microphones of the second microphone pair, and a line connecting two microphones of the third microphone pair are perpendicular to one another, and a line connecting two microphones of the fourth microphone pair, a line connecting two microphones of the fifth microphone pair, and a line connecting two microphones of the sixth microphone pair are perpendicular to one another.

16. The positioning system of claim 15, wherein the first orientation information and the second orientation information comprise the first orientation angle, the second orientation angle, and a distance between the first microphone array and the second microphone array, wherein the calculation device positions the location of the external device based on the first orientation angle, the second orientation angle, and the distance.

17. A positioning method comprising:
transmitting a radio frequency signal to an external device by a radio frequency device of a positioning system for pairing with the external device;
receiving an audio signal transmitted from the external device by a microphone array of the positioning system after the positioning system is paired with the external device;
calculating a direction from the positioning system to the external device based on a time interval of the audio signal received by the microphone array;
calculating a distance between the positioning system and the external device based on the audio signal transmitted by the external device after pairing; and
positioning a location of the external device according to the direction and the distance.

18. The positioning method of claim 17, wherein the microphone array comprises a plurality of microphones, the audio signal received by each two microphones of the microphones has the time interval, wherein calculating the direction from the positioning system to the external device based on the time interval of the audio signal received by the microphone array comprises:
calculating the direction from the positioning system to the external device based on at least two of the time intervals.

19. The positioning method of claim 17, wherein the microphone array comprises a first microphone, a second microphone, and a third microphone, wherein the positioning method further comprises:
receiving the audio signal by the first microphone at a first time;
receiving the audio signal by the second microphone at a second time;
receiving the audio signal by the a third microphone at a third time; and
calculating a first time interval based on the first time and the second time, and calculating a second time interval based on the second time and the third time;
wherein calculating the direction from the positioning system to the external device based on the time interval of the audio signal received by the microphone array comprises:
calculating the direction from the positioning system to the external device based on the first time interval and the second time interval.

20. The positioning method of claim 17, wherein calculating the distance between the positioning system and the external device based on the audio signal transmitted by the external device after pairing comprises:
transmitting a distance measuring signal to the external device by the positioning system after the positioning system is paired with the external device, the external device returning the audio signal to the positioning system at a first distance measuring time after receiving the distance measuring signal;
receiving the audio signal at a second distance measuring time by the positioning system; and
calculating the distance between the positioning system and the external device based on the first distance measuring time and the second distance measuring time.
